(19) United States
(12) Patent Application Publication
(10) Pub. No.: US 2008/0313309 A1
(43) Pub. Date: Dec. 18, 2008

(54) CLIENT-SERVER DATA TRANSFER CONTROL

(76) Inventor: Pradipta Kumar Banerjee, Bangalore (IN)

Correspondence Address: IBM CORP (YA);C/O YEE & ASSOCIATES PC, P.O. BOX 802333, DALLAS, TX, 75380, US

(21) Appl. No.: 11/764,337

(22) Filed: Jun. 18, 2007

(51) Int. Cl. G06F 15/16; G06F 17/00

(52) U.S. Cl. 709/219; 709/232

(57) ABSTRACT

Disclosed are a method, a client/server system and a computer program for controlling the data transfer from a server system to a client system that runs remotely an application on the server. The data transfer control is effected by defining a first trigger event and a second trigger event in the client system. The client system and the server are arranged so that an occurrence of a first trigger event terminates the transfer of at least one type of data from the server system to the client computer, while an occurrence of the second trigger event reintroduces the terminated data transfer.

### TECHNICAL FIELD

The present invention relates to a method and a system for controlling communication between a local client system and a remote server, and in particular, for controlling the data transfer between the remote server and the local client system during client/server interfacing.

### BACKGROUND OF THE INVENTION

The increased bandwidth of modern networks allows an increased number of computer program algorithms to be executed and controlled remotely. Thus, a local client system, such as a computer system, mobile phone, etc., with relatively low computational capabilities, can be connected to run a program algorithm on a remote server with superior computational power. However, logging to a remote server and executing commands, such as “TELNET”, “RSH” and “SSH”, often results in continuous communication being established between the client system and the remote server. While this communication is important for obtaining information of the status of the respective task carried on the remote server, usually a user is interested only in the final result, i.e. whether the task has been completed successfully or ended abruptly, resulting in an error message. At the same time, because of the communication link maintained between the remote server and the local client system, a certain amount of bandwidth is continuously being used by the application. This causes wastage of network bandwidth and computational resources. The problem is especially acute when using slow links and wireless networks.

Various solutions addressing these drawbacks are already in use. For example, program commands are known that redirect the standard output and/or the standard error output of the server to specific files, instead of to the client's system. However, such alternates are not user friendly since special commands and command options need to be used. Thus, a casual user may be unaware of the particular stream redirection procedure or the syntax of such special commands. In addition, some of these commands are available only on selected operating systems.

Thus, it is preferable to provide users with an improved solution that is transparent, easy to implement and applicable to a wide range of operating systems.

### SUMMARY OF THE INVENTION

According to a first aspect of the invention, there is provided a method for controlling data transfer between a client system and a server system. The client system runs an application remotely on the server system. The method includes defining a first trigger event and a second trigger event in the client system. The transfer of at least one type of data from the server system to the client system is terminated upon occurrence of the first trigger event. The terminated data transfer from the server system to the client system is reintroduced upon occurrence of the second trigger event.

According to a second aspect of the invention, there is provided a client/server system comprising a client system running an application remotely on a server system. The client/server system is arranged for controlling the data transfer from the server system to the client system by defining a first trigger event and a second trigger event in the client system. The transfer of at least one type of data from the server system to the client system is terminated upon occurrence of the first trigger event. The terminated data transfer from the server system to the client system is reintroduced upon occurrence of the second trigger event.

According to a third aspect of the invention, there is provided a computer program product comprising a computer usable medium including a computer readable program. The computer readable program is executed on a networked system including a client system and a server system, wherein the client system runs an application on a server system remotely. When executed, the computer program causes a first trigger event and a second trigger event to be defined in the client system. The program further causes the transfer of at least one type of data from the server system to the client system to be terminated, upon occurrence of the first trigger event, and to be reintroduced, upon occurrence of the second trigger event.

### BRIEF DESCRIPTION OF THE DRAWINGS

At least one embodiment of the present invention will now be described, by way of an example only and with reference to the accompanying drawings, wherein:

FIG. 1 is a schematic diagram of a client/user system in which the present invention can be implemented.

FIG. 2 is a schematic diagram of the process of data transfer between the client computer and the remote server of FIG. 1.

FIG. 3 is a schematic process diagram of the method for controlling the data transfer between the local client computer and the remote server, according to the invention.

FIG. 4 is the schematic diagram of the client/user system of FIG. 1, wherein the main components of the client system have been indicated.

### DETAILED DESCRIPTION

### Overview

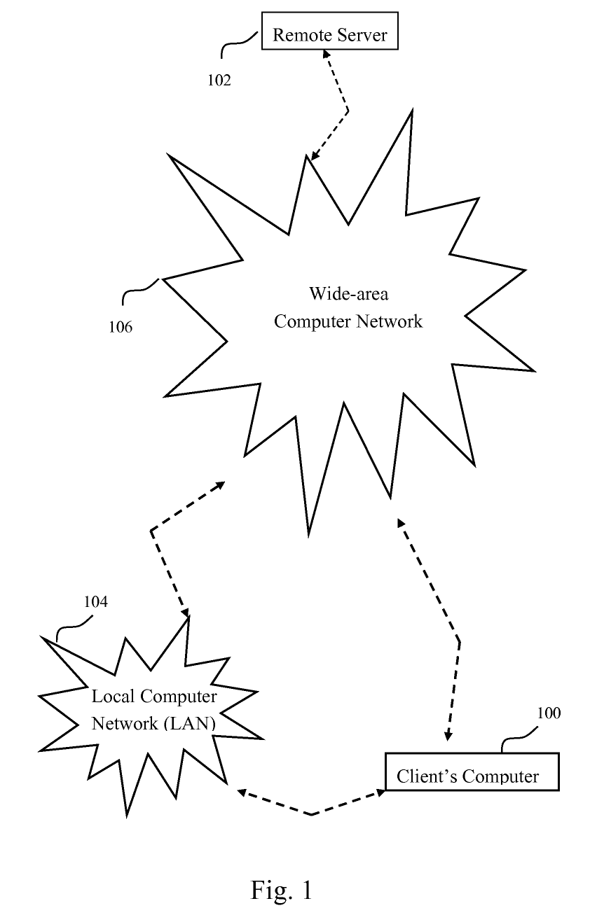

FIG. 1 illustrates the general application environment for the present invention. A client system 100 (hereinafter also referred to as a client or client computer system or client computer or client terminal), for example a computer system, a mobile phone, a personal digital assistant, a laptop computer and the likes, uses its network connection to log (connect) to a remote server 102. The specific nature of the network and the network connections used is unimportant. For example, as shown in FIG. 1, the network connection could be via a Local Area Network (LAN) 104, a Wide Area Network (WAN) 106, a wired connection or a wireless connection or a combination thereof. The server 102 can additionally serve a plurality of client computers 100.

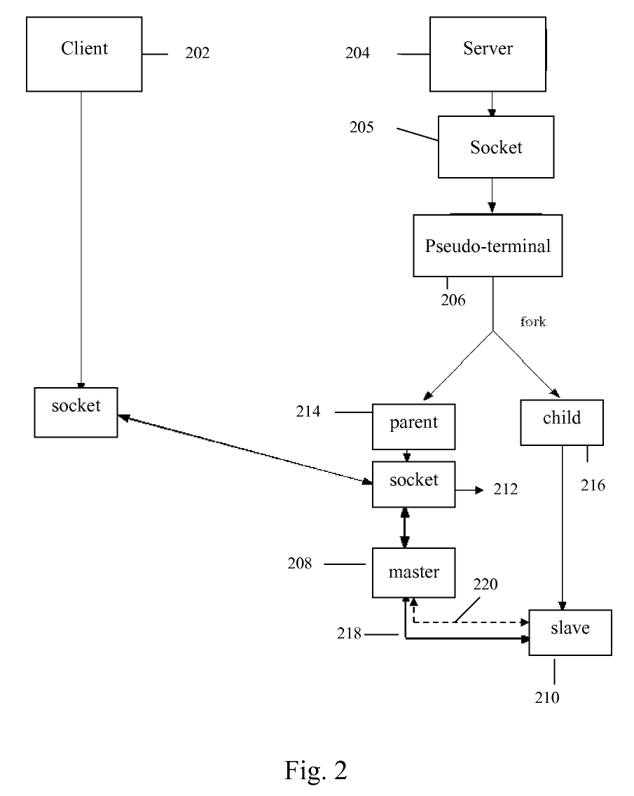

FIG. 2 represents an interface 200 between a user's local client computer 202 and a remote server 204. Normally, remote login or remote program execution of handlers such as “RLOGIN”, “SSH” and “RSH” makes use of the concept of a “pseudo-terminal”. As indicated in FIG. 2, a “pseudo-terminal” 206 can be represented by a pair of virtual devices 214 and 216 that provide a bidirectional communication channel 218. The first end 208 of the channel 218 is called “master”, while the second end 210 is called “slave”.

A software process that expects to be connected to the local client computer 202 can open the slave 210 and then be driven by a program that has opened the master 208. Anything that is written on the master 208 is provided to the process on the slave 210, as though it was an input typed on a terminal. Similarly, anything that is output on the slave 210 reaches the master 208. Thus, any program or command executed on the remote server 204 is effectively executed on the slave 210, whereas the master 208 takes care of transmitting the data to the local client computer 202, using the sockets 212 and 213.

Provided below are the pseudo-codes for a remote server/client system configuration, such as the configuration shown in FIG. 1. The pseudo-codes follow C-programming syntax, however error handling and other unrelated details are omitted for clarity.

```
Pseudo-code of a simple remote program execution server
    int main(int argc, char *argv[ ])
    {
      sd = socket( );
      bind(sd);
      listen(sd);
      sock = accept(sd);
      /* forkpty creates a pseudo-terminal device and creates a
    parent and child process */
        switch (forkpty (&pty )) /* pty = pseudo-terminal master
    end descriptor */
        {
            case −1: /* Error */
                    perror (“fork( )”);
                    exit (1);
            case 0: /* This is the child process */
                    close (sock);
                    exec(cmd); /* Execute the command/program */
                    perror(“exec( )”); /* Since exec never return */
                    exit (1);
            default: /* This is the parent process */
                /* use read( ) and write( ) in a loop to copy
    everything that come from the master
                  (pty) to the socket and vice versa.
                    */
                    while (1) {
                        select(pty,sock);
                        if (fd_isset(sock)) {
                            ret = read(sock, buf);
                        /* exit on any error */
                        if (ret == error)
                          exit (−1) ;
                            ret = write(pty, buf);
                        /* exit on any error */
                        if (ret == error)
                          exit (−1) ;
                        }
                        if (fd_isset(pty)) {
                            ret = read(pty, buf);
                        /* exit on any error */
                        if (ret == error)
                          exit (−1) ;
                            ret = write(sock,buf);
                        /* exit on any error */
                        if (ret == error)
                          exit (−1) ;
                    }
                }
      }
    }
Pseudo-code for the “forkpty” function
    int forkpty(int *amaster)
    {
      /*get a pseudo-terminal master-slave pair */
      master = getpt( );
      *amaster = master;
      grantpt(master);
      unlockpt(master);
      slave_name = ptsname(master);
      slave = open(slave_name);
      pid = fork( );
      switch(pid) {
            case −1 : /* Error */
                return −1 ;
            case 0 : /* Child */
                close(master);
                dup2(slave, STDIN_FILENO);
                dup2(slave, STDOUT_FILENO);
                dup2(slave, STDERR_FILENO);
            default: /* Parent */
                close(slave);
                    return pid;
      }
      return −1;
    }
Pseudo-code of a simple remote program execution client
    int main(int argc, char *argv[ ])
    {
      cd = socket( );
      connect(cd);
      /* Send the command to be executed to the server and
        read the data sent on the socket by the server and display
        it locally
      */
      send(cd, cmd);
      while(1) {
                ret = read(cd, buf);
            /* Exit on error or end-of-file */
            if ( (buf == EOF) or (ret == error) )
                    exit( );
            write(stdout, buf);
      }
      return 0;
    }
```

As it can be inferred from the above pseudo-code, the remote server 204 multiplexes the standard input, standard output and standard error data of the process at the slave 210 of the pseudo-terminal 206. Any input data coming from the client computer 202 on the socket 212 is transmitted to slave 210 via master 208. Similarly, any standard output or standard error data from the process goes to the master 208, via the slave 210, and ultimately to the client computer 202, via the socket 212. In addition, the “forkpty” function creates a fork comprising parent process 214 and child process 216. It should be apparent to one skilled in the art that other programming languages may be used to provide the remote server/client system configuration code, wherein the same logic or algorithm described above may be translated into pseudo-code, and any such code falls within the scope of the invention.

### Embodiment of the Invention

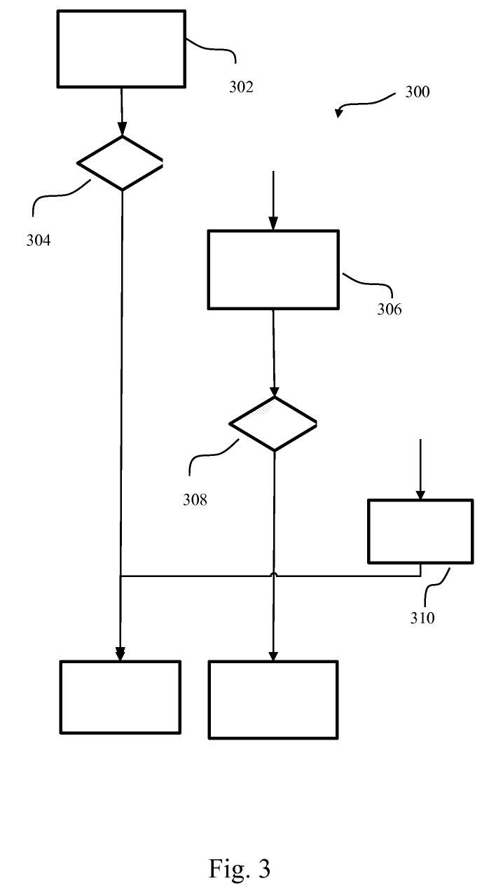

An embodiment is illustrated in FIG. 3. In particular, a method 300 for controlling the data transfer between a client system and a server computer system (also referred to as a server or remote server or server system) in a case, where the client system runs an application remotely on the server system, is shown. The method begins with step 301, including defining a “first” trigger event and a “second” trigger event in the client system. If the local client system is a computer, the “first” and “second” events may be set up by the respective system administrator of the local client system or may be provided by a pre-defined set of rules, wherein the rules may be changed by the user/administrator whenever required. Alternatively, users of the system may be given the opportunity to define the events themselves. If the local client system is, for example, a mobile phone, the trigger events can be set-up during the production stage of the device or be again defined by the user. Various predetermined events can be defined as “first” and “second” trigger events. For example, the event of minimisation of the application window of the respective application (that is run remotely by the server on the client computer screen) can be defined as a “first” event. On the other hand, the event of maximisation of the previously minimised application window of the respective application can be used as a “second” trigger event. Thus, under the above assumptions, if the application window was minimised, a first event is detected by the client computer in step 304 and the remote server is notified. In response, the transfer from the server system to the client system of at least one type of data is terminated in step 306. When the user indicates a renewed interest to the application, by maximising the application window on the clients display, the client computer detects the occurrence of the “second” event in step 308 and notifies the remote server. As a result, the terminated data transfer from the server to the client computer is reintroduced in step 310. A skilled person may attribute various other trigger event associated with the client operation, for example opening a file and closing a file, and associate each of these trigger events with the first and second trigger event and such trigger events fall within the scope of this invention.

An implementation of the preferred embodiment will now be described by way of example related to a Unix™ environment and associated system calls. However, it will be appreciated by a skilled addressee that the invention is not limited to any particular operating system or programming environment, and any such operating systems or programming environments fall within the scope of this invention.

As discussed above, the preferred embodiment includes sending a notification from the client computer 100 to the remote server 102, when the application window is maximized or minimized. Protocols such as “SSH” define explicit codes for sending client side application window changes. Code can be used in a similar way for notifying the remote server 102 for the occurrence of window minimization/maximization, as appropriate. Referring again to FIG. 2, one possible way to implement this process would be to run a separate algorithm in the client computer 202, which looks for the occurrence of window maximization/minimisation and, upon detection of such occurrence, immediately sends a notification to the server 204 as out-of-band or urgent data. If it is desired to allow the display of standard error data output irrespective of the state of the client side window, the standard error data output from the slave 210 in the remote server needs to be de-multiplexed. This can be implemented by using a pipe 218 for standard error data communication between the master 208 and the slave 210. Under this arrangement, the slave 210 writes to the “write” end of the pipe 218 and the master 208 reads from the “read” end of the pipe 218. On receiving any data at the “read” end of the pipe, the data is sent to the client 202 via the socket 212.

The modified pseudo-code for the server 102 and the client 100 in accordance with a preferred embodiment is given below.

```
Modified pseudo-code of the remote execution server in accordance with a
preferred embodiment
    int main(int argc, char *argv[ ])
    {
      sd = socket( );
      bind(sd);
      listen(sd);
      sock = accept(sd);
      /* forkpty creates a pseudo-terminal device and creates
    a parent and child process */
      switch (forkpty (&pty )) /* pty = pseudo-terminal master
      end descriptor
    */
      {
            case −1: /* Error */
                    perror (“fork( )”);
                    exit (−1);
            case 0: /* This is the child process */
                close (sock);
                /* Execute the command/program received from
the client */
                    exec(cmd);
                    perror(“exec( )”);
                exit (−1);
            default: /* This is the parent process */
                    while (1) {
                    FD_ZERO (&descriptor_set);
                        FD_SET (sock, &descriptor_set);
                        FD_SET (pty, &descriptor_set);
                        FD_SET (pfd[0], &descriptor_set);
                    select (FD_SETSIZE, &descriptor_set);
                        if (fd_isset(sock,&descriptor_set)) {
                            ret = read(sock, buf);
                        /* exit on any error */
                        if (ret == error)
                          exit (−1) ;
                            /* check if the received data is
                          a window minimized information
                        */
                        if (buf == WINDOW_MINIMIZED) {
                            disable_stdout = 1;
                            } elseif (buf ==
    WINDOW_MAXIMIZED) {
                            disable_stdout = 0;
                            } else {
                            write(pty, buf);
                            }
                        }
                        if (fd_isset(pty,&descriptor_set)) {
                            ret = read(pty, buf);
                        /* exit on any error */
                        if (ret == error)
                          exit (−1) ;
                            /* Send data to client only if stdout
    enabled */
                            if (!disable_stdout) {
                                ret = write(sock,buf);
                            /* exit on any error */
                            if (ret == error)
                                exit (−1) ;
                            }
                        }
                    /* process wrote something to stderr */
                        if (fd_isset(pfd[0],&descriptor_set)) {
                            ret = read(pfd[0], buf);
                        /* exit on any error */
                        if (ret == error)
                          exit (−1) ;
                            /* Send stderr data to the client */
                            ret = write(sock,buf);
                        /* exit on any error */
                        if (ret == error)
                          exit (−1) ;
                        }
                }
      }
    }
Modified pseudo-code for the “forkpty” function in accordance with
the preferred embodiment
    int forkpty(int *amaster)
    {
      /*get a pseudo-terminal master-slave pair */
      /* master = descriptor for the master */
      /* slave = descriptor for the slave */
      master = getpt( );
      *amaster = master;
      grantpt(master);
      unlockpt(master);
      slave_name = ptsname(master);
      slave = open(slave_name);
      /* create pipe for handling stderr separately*/
      pipe(pfd);
      pid = fork( );
      switch(pid) {
            case −1 : /* Error */
                return −1 ;
            case 0 : /* Child */
                close(master);
                /* close read end of the pipe. Child will only
    write to the pipe */
                close(pfd[0]);
                dup2(slave, STDIN_FILENO);
                dup2(slave, STDOUT_FILENO);
                /*duplicate stderr to the write end of the pipe*/
            dup2(pfd[1], STDERR_FILENO);
                default: /* Parent */
                close(slave);
    /* close write end of the pipe. Parent will only read from
    the pipe */
                    close(pfd[1]);
                    return pid;
      }
      return −1;
    }
Modified pseudo-code of the remote execution client in
accordance with the preferred embodiment
    int main(int argc, char *argv[ ])
    {
      cd = socket( );
      connect(cd);
      /* Send the command to be executed to the server and
        read the data sent on the socket by the server and
      display it locally */
      pid = fork( );
      switch (pid) {
            case −1: /* Error */
                    perror (“fork( )”);
                    exit (−1);
            case 0: /* This is the child process */
                while (1) {
                    /* Block for window
                    maximize/minimize events */
                    block_on_window_events(&event);
                    /* Send window maximize/minimize
    information to the server */
                    if (event == WINDOW_MINIMIZED) {
                        /* send as out-of-band data */
                            send(cd,WINDOW_MINIMIZED);
                    }
                    if (event == WINDOW_MAXIMIZED) {
                        /* send as out-of-band data */
                            send(cd,WINDOW_MAXIMIZED);
                    }
                }
            default : /* Parent process*/
                while(1) {
                        if (cmd) {
                        ret = send(cd, cmd);
                        /* exit on any error */
                        if (ret == error)
                          exit (−1) ;
                        ret = read(cd, buf);
                        /* Exit if error or end-of-file */
                        if ( (buf == EOF) or (ret == error) )
                            exit( );
                        ret = write(stdout, buf);
                        /* exit on any error */
                        if (ret == error)
                          exit (−1) ;
                    }
                }
      }
    }
```

According to the above modified pseudo-code, the remote server 204 multiplexes the standard input and standard output of the child process 216 (which ultimately will execute the command/program) to the slave 210 of the pseudo-terminal 206. The pipe 218 is created to handle the standard error output communication between the parent process 214 and the child process 216. Any input coming from the client on the socket 212 is transferred to the slave 210 via the master 208, handled by the parent process 214. Any output from the child process 216 is sent to the master 208 via the slave 210 and, ultimately, to the client 202, via the socket 212. The standard output is sent to the client 202 via the socket 212 only when the standard output communication is not disabled via a request from the client 202. Any error from the child process 216 is sent to the master 214, via the pipe 218 and, ultimately, to the client 202, via the socket 212. The client 202 runs a separate algorithm to check for the window minimize/maximize event. If an event of window “minimisation” is detected, the transmission of standard output data to the client is disabled. In the case of window “maximisation” event, on the other hand, the standard output data to the client is re-enabled

The method and the system of the preferred embodiment effectively offer a mechanism that disables the standard output of the remote process, when the minimized client application window indicates a lack of interest on behalf of the user of the computer 100, and enables the standard output only when the application window is maximized, indicating a renewed interest on the user's behalf. Such an arrangement saves network bandwidth, since it prevents a continuous information exchange while the application window is minimised.

Although it is possible to arrange the system so that minimisation of the application window would also disable the standard error function output of the remote process, doing so is not advisable. Such disablement would make it impossible to check whether the application has been successfully executed or it has generated an error message. If, for some reason, the standard error function output has to be disabled, a provision needs to be made for buffering any standard error data, and subsequently sending it to the local client computer, once the respective application window is maximized.

To illustrate the above discussion, reference will be made to a client/server system such as that of FIG. 1, where the client computer 100 performs a “SOURCE BUILD” on the remote server 102. The “SOURCE BUILD” output would be displayed on the screen of the client computer 100. When the application window displayed on the local client computer 100 is minimized, the standard data output of the remote “SOURCE BUILD” process is disabled and the server 102 stops sending any more standard data output to the client 100. No further output is displayed on the local client computer 100. When the client computer application window associated with the “SOURCE BUILD” process is maximized again, the standard data output of the remote “SOURCE BUILD” process is re-enabled and output is displayed on the application window of the client computer 100, so that the user can check the status of the process. In case of successful completion, the last received standard data output or a success-notification is sent to the client. If an error occurs during the execution of the application, an error message is sent to the client computer 100.

It is clear from the above description that the preferred embodiment of the present invention offers an easy to implement method for optimising the bandwidth usage during client/server interface. There is no need to use special commands and command options, the solution is transparent and does not depend on the knowledge and the training of the user. Furthermore, the solution offered by the preferred embodiment does not depend on the availability of special commands for a particular operating system and is, therefore, operating system neutral. The benefits are especially valuable in enabling usage of remote shells in bandwidth constraint wireless networks.

### Computer Platform

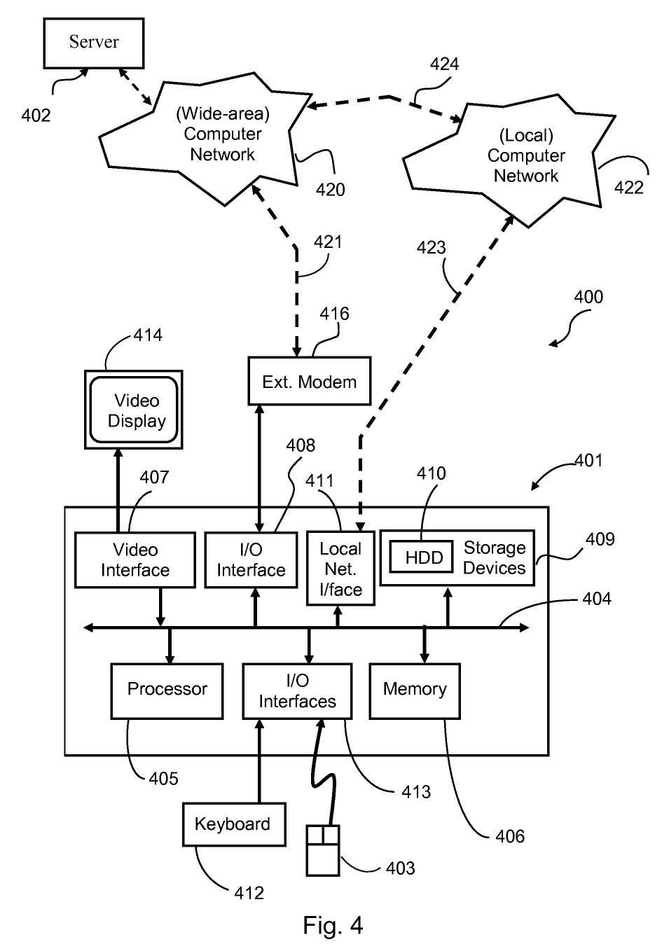

FIG. 4 shows a schematic block diagram of a client/server system 400, with which the arrangements described above with respect to FIGS. 2 and 3 can be implemented in the form of application programs executable within the general purpose client computer system 401 and/or the server computer system 402, respectively. The software (algorithm or pseudo-code or set of instructions defined by the algorithm) presented in the above text, or any other software implementing the above described functionalities, may be stored in a computer readable medium including storage devices. In the case illustrated in FIG. 4, the software is loaded into the client computer 401 from the computer readable medium 410 and then executed by the computer 401. A computer readable medium having such software or computer program recorded on it is a computer program product.

As seen in FIG. 4, the client computer system 401 can include input devices such as a keyboard 402 and a mouse pointer device 403, and output device such as display device 414. In this configuration, the client computer 401 is still preferably connected to the server computer 402 and to any other computer systems via a network as data conversion is a means usually utilized when the data needs to be used by multiple computer systems often communicating with each other over a network. An external Modulator-Demodulator (Modem) transceiver device 416 may be coupled to the computer 401 for communicating to and from a communications network 420 via a connection 421. The network 420 may be a wide-area network (WAN), such as the Internet, or a private LAN.

The client computer 401 typically includes at least one processor unit 405, and a memory unit 406 for example formed from semiconductor random access memory (RAM) and read only memory (ROM). Here, the processor unit 405 is an example of a processing means which can also be realized with other forms of configuration performing similar functionality. The client computer 401 also includes an number of input/output (I/O) interfaces including a video interface 407 that couples to the video display 414, an I/O interface 413 for such devices like the keyboard 402 and mouse 403, and an interface 408 for the external modem 416. In some implementations, the modem 416 may be incorporated within the computer 401, for example within the interface 408. The client computer 401 may also have a local network interface 411 which, via a connection 423, permits coupling of the computer system 400 to a local computer network 422, known as a Local Area Network (LAN). As also illustrated, the local network 422 may also couple to the wide network 420 via a connection 424, which would typically include a so-called “firewall” device or similar functionality. The interface 411 may be formed by an Ethernet™ circuit card, a wireless Bluetooth™, an IEEE 802.11 wireless arrangement or a combination of thereof.

Storage devices 409 are provided and typically include a hard disk drive (HDD) 410. It should be apparent to a person skilled in the art that other devices such as a floppy disk drive, an optical disk drive and a magnetic tape drive (not illustrated) may also be used. The components 405 to 413 of the client computer 401 typically communicate via an interconnected bus 404 and in a manner which results in a conventional mode of operation of the computer system 400.

Typically, the client programming modules, as discussed above, are resident on the storage device 409 and read and controlled in execution by the processor 405. Storage of intermediate product from the execution of such programs may be accomplished using the semiconductor memory 406, possibly in concert with the storage device 409. In some instances, the application programs may be supplied to the user encoded on one or more CD-ROM or other forms of computer readable media and read via the corresponding drive, or alternatively may be read by the user from the networks 420 or 422.

While the invention has been hereby described by using an example that is believed to cover the most practical and preferred embodiment, it would be clear to a person skilled in the art that other embodiments and variations will also be within the scope of the main concept of the invention. For example, apart from the above discussed events of minimizing/maximizing the application window, other events indicative of whether the user's attention is focused on the particular application can also be used as “first” and/or “second” events. Such events could for example be associated with whether, and for how long, has the respective application window been left inactive; the idle time of the user's keyboard and/or mouse; or whether a new window associated with another application has been opened or closed. Depending of the particular circumstances, the opening of any new application or only the opening of predetermined applications may be defined as “first” and/or “second” trigger events. In addition, instead of a single event, two or more events may be simultaneously defined as “first” and/or “second” events, so that the occurrence of any of these events can trigger a termination and/or reintroduction, of the respective data transfer. The “first” event/s may be the same or different from the “second” event/s. For example, the event of three consecutive clicks of a button of the mouse, operated with the local client computer, may be defined as both “first” and “second” event. Alternatively, three consecutive clicks may be defined as a “first” event, while four consecutive clicks may be defined as a “second” event.

We claim:

1. A method for controlling data transfer between a client system and a server system, the client system running an application remotely on the server system, the method comprising:
defining a first trigger event and a second trigger event in the client system;
terminating the transfer of at least one type of data from the server system to the client system upon occurrence of the first trigger event; and
reintroducing the terminated data transfer from the server system to the client system upon occurrence of the second trigger event.

2. The method of claim 1, wherein the first trigger event is defined by the application being inactive for a predetermined length of time.

3. The method of claim 1, wherein the first trigger event is defined by the absence of an input signal to the client system for a predetermined length of time.

4. The method of claim 2, wherein the first trigger event is the occurrence of minimisation of a window presented on the screen of the client system, the window corresponding to the application that is run remotely by the client system on the server system

5. The method of claim 1, wherein the second trigger event is the occurrence of maximisation of the minimised window.

6. The method of claim 1, wherein the first and the second trigger events are defined by an opening and closing of a window of another application, respectively.

7. The method of claim 1, wherein the at least one type of data includes at least one of text, graphics, standard output and standard error data.

8. A client/server system comprising a client system running an application remotely on a server system, the client/server system being arranged for controlling the data transfer from the server system to the client system by:
defining a first trigger event and a second trigger event in the client system;
terminating the transfer of at least one type of data from the server system to the client system, upon occurrence of the first trigger event; and
reintroducing the terminated data transfer from the server system to the client system upon occurrence of the second trigger event.

9. The system of claim 8, wherein the first trigger event is defined by the application being inactive for a predetermined length of time.

10. The system of claim 8, wherein the first trigger event is defined by the absence of an input signal to the client system for a predetermined length of time.

11. The system of claim 9, wherein the first trigger event is the occurrence of minimisation of a window presented on the screen of the client system, the window corresponding to the application that is run remotely by the client system on the server system.

12. The system of claim 8, wherein the second trigger event is the occurrence of maximisation of the window.

13. The system of claim 8, wherein the first and the second trigger events are defined by an opening and closing of a window of another application, respectively.

14. The system of claim 8, wherein the at least one type of data includes at least one of text, graphics, standard output and standard error data.

15. A computer program product comprising a computer usable medium including a computer readable program, wherein the computer readable program, when executed on a networked system including a client system and a server system, the client system remotely running an application on the server system, causes:
defining a first trigger event and a second trigger event in the client system;
terminating the transfer of at least one type of data from the server system to the client system, upon occurrence of the first trigger event, and
reintroducing the terminated data transfer from the server system to the client system upon occurrence of the second trigger event.

16. A signal bearing medium tangibly embodying a set of machine readable instruction when executed on a processor of a networked system including a client system and a server system, the client system configured to remotely execute an application on the server system, causes:
defining a first trigger event and a second trigger event in the client system;
terminating the transfer of at least one type of data from the server system to the client system, upon occurrence of the first trigger event, and reintroducing the terminated data transfer from the server system to the client system upon occurrence of the second trigger event.

17. The system of claim 16, wherein the first trigger event is defined by the application being inactive for a predetermined length of time.

18. The system of claim 16, wherein the first trigger event is defined by the absence of an input signal to the client system for a predetermined length of time.

19. The system of claim 16, wherein the at least one type of data includes at least one of text, graphics, standard output and standard error data.
